(19) United States
(12) Patent Application Publication
(10) Pub. No.: US 2011/0117330 A1
(43) Pub. Date: May 19, 2011

(54) WRITING PAPER AND METHOD FOR MANUFACTURING WRITING PAPER

(75) Inventor: Jun Yamazaki, Tokyo (JP)

(73) Assignee: OBUN PRINTING COMPANY, INC., Bunkyo-ku, Tokyo (JP)

(21) Appl. No.: 12/737,359

(22) PCT Filed: May 15, 2009
(86) PCT No.: PCT/JP2009/059028

§ 371 Date: Jan. 4, 2011

(30) Foreign Application Priority Data
Jul. 8, 2008 (JP) 2008-177494

(51) Int. Cl. B32B 3/10; B32B 7/02; B05D 1/36; B05D 3/06; B41F 33/00

(52) U.S. Cl. 428/195.1; 428/213; 427/411; 427/510; 427/258; 101/483

(57) ABSTRACT

Writing paper that exhibits an excellent writing capability and erasability when using a whiteboard marker, and is not easily damaged, and a method of producing the same are disclosed. The writing paper includes a first coating layer formed by applying a first coating material to one side or each side of paper, and a second coating layer formed by applying a second coating material to the first coating layer, the first coating material and the second coating material being UV-curable, and the second coating layer having a thickness larger than that of the first coating layer.

### TECHNICAL FIELD

The invention relates to writing paper. In particular, the invention relates to writing paper that allows writing using a whiteboard marker or the like and erasure thereof, and a method of producing the same.

### BACKGROUND ART

In recent years, a whiteboard has been widely used instead of a blackboard. A whiteboard allows easy writing and erasure using a dedicated marker and an eraser. Moreover, unlike the case where a blackboard, which needs a piece of chalk, is used, powder or waste does not generate during erasure, whereby a whiteboard is allowed to be easier to use than ever.

On the other hand, a whiteboard is relatively large since a whiteboard is designed on the assumption that it is used by a plurality of persons. Therefore, a whiteboard is normally fixed at a given location during use.

It is very convenient if it is possible to provide a portable article (e.g., writing paper) with the capability to allow easy writing and erasure using a dedicated marker or the like in the same manner as a whiteboard. In this case, it is desirable to use a flexible material (e.g., paper) instead of a hard plate (e.g., whiteboard) from the viewpoint of convenience.

Examples of technology relating to writing paper having the capability to allow writing and erasure in the same manner as a whiteboard include a white notebook disclosed in Patent Document 1, a soft writing board disclosed in Patent Document 2, writing paper disclosed in Patent Document 3 that allows easy erasure/correction of characters or figures, and an erasable article and a method of producing the same disclosed in Patent Document 4.
Patent Document 1: JP-A-2007-83406
Patent Document 2: JP-UM-A-4-113992
Patent Document 3: JP-B-50-25047
Patent Document 4: JP-T-2005-537951

### DISCLOSURE OF THE INVENTION

### Problems to be Solved by the Invention

The white notebook disclosed in Patent Document 1 is obtained by treating the surface of white paper with a synthetic resin such as polypropylene or polyvinyl chloride. Therefore, the synthetic resin coating is easily removed from the paper, and the writing capability significantly decreases when the notebook is bent. Moreover, since the synthetic resin coating has a single-layer structure, erasability is insufficient as compared with the writing capability.

The soft writing board disclosed in Patent Document 2 is produced by forming a polyvinyl chloride resin layer on the surface of lining paper, applying a UV-curable paint to the polyvinyl chloride resin layer, and curing the UV-curable paint by applying ultraviolet rays (UV) to form a surface that allows writing and erasure using a given writing material.

In this case, the polyvinyl chloride resin layer may be removed from the lining paper, and the writing capability decreases in a bent area. Moreover, it is difficult to improve both writing capability and erasability.

The writing paper disclosed in Patent Document 3 that allows easy erasure/correction of characters or figures is obtained by coating paper with a solution or a dispersion of chlorosulfonated polyethylene by a spray method or a coating method. Patent Document 3 states that delamination rarely occurs differing from a configuration in which a plastic film is merely laminated on paper, and the writing paper can endure repeated writing and correction.

However, the writing paper disclosed in Patent Document 3 has a problem in that erasability is insufficient as compared with the writing capability. Moreover, since the writing paper disclosed in Patent Document 3 is obtained by coating paper with a solution or a dispersion of chlorosulfonated polyethylene by a spray method or a coating method, the writing paper cannot be mechanically produced using an existing apparatus, and it is difficult to apply the solution or the like to each side of paper, and to provide the writing paper with post-processability.

Patent Document 4 states that cracks and breakage do not occur in the base and the coating layer of the erasable article, and the coating layer is not removed from the base.

However, erasability is insufficient when using a single coating layer. An improvement in erasability obtained by utilizing two coating layers is insufficient. Therefore, it is difficult to improve both writing capability and erasability.

The invention was conceived in view of the above situation. An object of the invention is to provide writing paper that exhibits an excellent writing capability and erasability when using a whiteboard marker, and is not easily damaged, and a method of producing the same, by coating one side or each side of paper with two or more coating materials (UV-curable paints) to form two or more layers, and forming a coating layer on a first coating layer formed on the paper to have a thickness larger than that of the first coating layer.

Another object of the invention is to provide a method of producing writing paper that makes it possible to easily print and cure a coating layer on one side or each side of paper using existing printing equipment, and easily form a layer with printed characters, figures, colors, and the like.

### Means for Solving the Problems

In order to achieve the above objects, the invention provides writing paper including a first coating layer formed by applying a first coating material to one side or each side of paper, and a second coating layer formed by applying a second coating material to the first coating layer, the first coating material and the second coating material being UV-curable, and the second coating layer having a thickness larger than that of the first coating layer.

The above configuring makes it possible to provide writing paper that exhibits an excellent writing capability and excellent erasability. The above configuring also makes it possible to provide writing paper that rarely suffers delamination (removal), cracks, scratches, and the like.

It is preferable that the second coating material have a viscosity lower than that of the first coating material.

This makes it possible to easily form the second coating layer to have a thickness larger than that of the first coating layer.

It is preferable that the first coating layer have been formed by applying the first coating material to the paper in an amount of 1 to 3 g/m², and the second coating layer have been formed by applying the second coating material to the first coating layer in an amount of 3 to 8 g/m².

This makes it possible to provide writing paper that exhibits excellent erasability, in particular.

It is preferable that the first coating material and the second coating material include at least 70 to 90 wt % of an acrylic monomer, 0 to 20 wt % of an oligomer, and 1 to 10 wt % of a photoinitiator.

This makes it possible to quickly cure the coating layer by applying ultraviolet rays, so that the erasability of the writing paper can be improved.

It is preferable that the second coating material include a silicone compound.

This further improves the erasability of the writing paper.

It is preferable that the writing paper further include a printing ink layer that includes a printing ink and is positioned between the first coating layer and the paper.

This makes it possible to provide writing paper (e.g., graph paper, coloring book, or calendar) that is provided with printed characters, figures, and the like, is rarely damaged, and exhibits an excellent writing capability and excellent erasability.

The writing paper according to the invention may be used as paper that forms a notebook, a portable whiteboard, simili paper, a coloring book, or a calendar, for example.

A method of producing writing paper according to the invention includes coating the entirety or part of one side or each side of paper with two or more UV-curable coating materials to form two or more coating layers on one side or each side of the paper.

The above method can produce writing paper that exhibits an excellent writing capability and excellent erasability, does not easily undergo delamination, and is not easily damaged.

The above method may further include curing the two or more coating layers before the coating material is absorbed into the paper so that holes are formed in the two or more coating layers.

This makes it possible to provide writing paper that exhibits excellent erasability since an ink does not enter holes during writing.

In the above method, at least the coating material that forms the outermost coating layer may include at least 70 to 90 wt % of an acrylic monomer, 0 to 20 wt % of an oligomer, 1 to 10 wt % of a photoinitiator, and 2 to 5 wt % of a silicone compound.

This makes it possible to quickly dry and cure the coating layer by utilizing such a coating material for the second coating layer and the like, so that writing paper that exhibits excellent erasability and does not have holes can be provided.

The above method may further include printing characters, figures, colors, and the like on the paper by process color printing, monochrome printing, or spot color printing using a printing press, and applying the coating material to a layer that includes the printed characters, figures, colors, and the like.

This makes it possible to provide writing paper (e.g., graph paper, calendar, or coloring book) that is provided with a printing ink layer, exhibits an excellent writing capability and excellent erasability, and is not easily damaged.

### Effects of the Invention

According the invention, it is possible to provide writing paper that exhibits an excellent writing capability and erasability when using a whiteboard marker, and is not easily damaged, and a method of producing the same, can be provided.

According the invention, it is possible to provide a method of producing writing paper that makes it possible to easily print a coating layer on one side or each side of paper using existing printing equipment, cure the coating layer by applying ultraviolet rays, and easily form a layer with printed characters, figures, colors, and the like.

### BRIEF DESCRIPTION OF THE DRAWINGS

FIG. 1 is a cross-sectional view showing the configuration of writing paper according to a first embodiment of the invention.

FIG. 2 is a view showing a portable whiteboard produced using the writing paper according to the first embodiment of the invention.

FIG. 3 is a view showing a process that produces the writing paper according to the first embodiment of the invention using an offset press.

FIG. 4 is a cross-sectional view showing the configuration of writing paper according to a second embodiment of the invention.

FIG. 5 is a view showing a calendar and graph paper produced using the writing paper according to the second embodiment of the invention.

FIG. 6 is a view showing a process that produces the writing paper according to the second embodiment of the invention.

FIG. 7 is a cross-sectional view showing the configuration of writing paper according to a third embodiment of the invention.

FIG. 8 is a view showing a notebook produced using the writing paper according to the third embodiment of the invention.

FIG. 9 is a cross-sectional view showing the configuration of writing paper according to a fourth embodiment of the invention.

FIG. 10 is a view showing a coloring book produced using the writing paper according to the fourth embodiment of the invention.

FIG. 11 is a view showing the writing test results for the writing paper according to the first embodiment of the invention.

### DESCRIPTION OF EXEMPLARY EMBODIMENTS

Preferred embodiments of the writing paper and the method of producing writing paper according to the invention are described below with reference to the drawings.

### First Embodiment

### Writing Paper

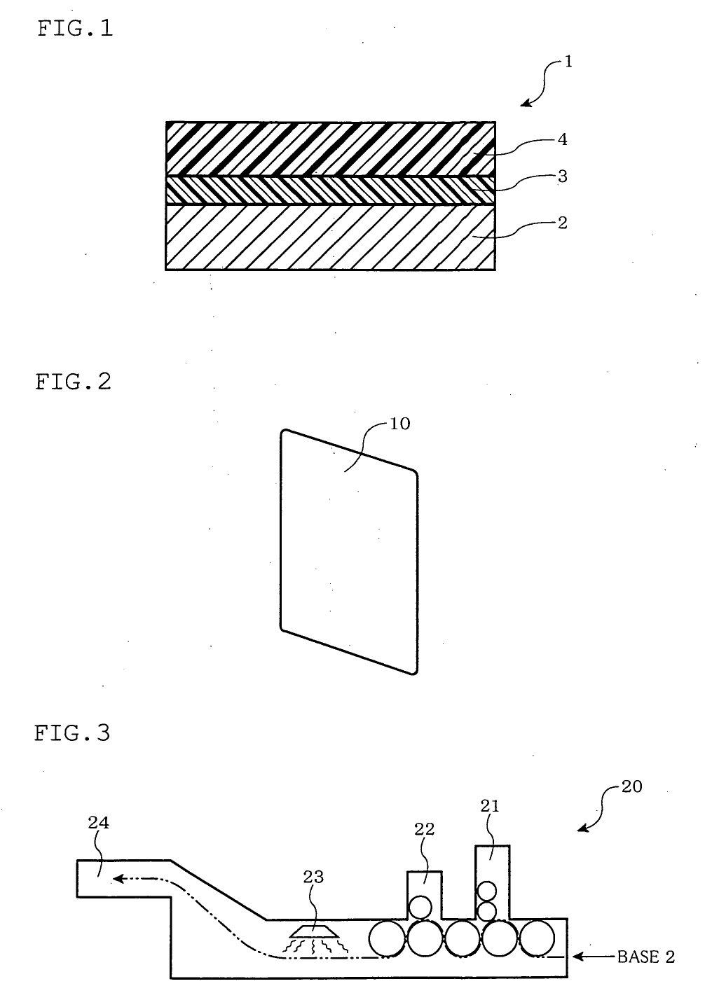

Writing paper according to a first embodiment of the invention is described below with reference to FIGS. 1 and 2. FIG. 1 is a cross-sectional view showing the configuration of the writing paper according to this embodiment, and FIG. 2 is a view showing a portable whiteboard produced using the writing paper according to this embodiment.

As shown in FIG. 1, writing paper 1 according to this embodiment includes a base 2, a first coating layer 3 that is formed of a first coating material, and a second coating layer 4 that is formed of a second coating material.

### (Base)

Normal printing paper may be used as the base 2 used in this embodiment. This also applies to other embodiments.

Therefore, the base 2 can be easily coated with a UV-curable varnish using a UV offset press or the like.

### (Coating Material)

In this embodiment, varnish may be used as the coating material. Varnish is a transparent coating material that is normally used to protect the surface of a material such as wood.

In this embodiment, it is preferable to use a UV-curable varnish. When using an oily varnish, the varnish may be absorbed into paper (i.e., the varnish layer may be impaired), so that the resulting writing paper 1 may not exhibit a sufficient writing capability and erasability.

When using a UV-curable varnish as the first coating material and the second coating material according to this embodiment, the coating material layers can be cured at the same time by applying ultraviolet rays, and exhibit excellent adhesion.

Therefore, the coating layer of the writing paper 1 is not easily removed, or does not easily crack (break).

### (A) First Coating Material

The first coating material is applied to the paper base. The first coating material is not particularly limited insofar as the first coating material is UV-curable. For example, a UV-curable ink or a UV-curable overprint varnish known in the art may be used.

The first coating material serves as a filler for minute depressions of paper. The first coating material also serves as an underlayer for the second coating material. The erasability of the writing paper 1 is improved by forming a coating layer having a two-layer structure using the first coating material and the second coating material.

### (B) Second Coating Material

The second coating material is applied to the first coating layer 3, and forms the second coating layer 4.

The second coating material is not particularly limited insofar as the second coating material is UV-curable, exhibits excellent adhesion to the first coating layer, and can be quickly dried. For example, a UV-curable clear coat varnish or the like may be used as the second coating material.

A UV-curable clear coat varnish can be dried and cured immediately after application (coating) using a UV offset press or the like.

A situation in which holes are formed in the film including the first coating layer 3 and the second coating layer 4 can be prevented by quickly drying and curing the UV-curable clear coat varnish. Specifically, holes are formed in the film if the coating material is absorbed into the base 2. In this case, a whiteboard marker ink may enter the holes, so that erasability may deteriorate.

Formation of holes can be prevented by drying and curing the coating material before the coating material is absorbed into the base 2, so that the erasability of the resulting writing paper 1 can be improved.

It is preferable that the second coating material have a composition that ensures quick drying. Specifically, a mixture that includes at least 70 to 90 wt % of an acrylic monomer, 0 to 20 wt % of an oligomer, and 1 to 10 wt % of a photoinitiator is preferably used as the second coating material.

The following monofunctional, difunctional, trifunctional, and polyfunctional monomers may be used as the acrylic monomer. These monomers may be used either individually or in combination.

Examples of the monofunctional monomer include lauryl(meth)acrylate, stearyl (meth)acrylate, tetrahydrofurfuryl(meth)acrylate, caprolactone-modified tetrahydrofurfuryl(meth)acrylate, cyclohexyl(meth)acrylate, dicyclopentanyl (meth)acrylate, isobornyl(meth)acrylate, benzyl(meth)acrylate, phenyl(meth)acrylate, phenoxy diethylene glycol (meth)acrylate, phenoxy tetraethylene glycol (meth)acrylate, nonylphenoxyethyl(meth)acrylate, nonylphenoxy tetraethylene glycol (meth)acrylate, methoxy diethylene glycol (meth)acrylate, ethoxy diethylene glycol (meth)acrylate, butoxyethyl(meth)acrylate, butoxy triethylene glycol (meth)acrylate, 2-ethylhexyl polyethylene glycol (meth)acrylate, nonylphenyl polypropylene glycol (meth)acrylate, methoxy dipropylene glycol (meth)acrylate, glycidyl(meth)acrylate, N-vinylpyrrolidone, 2-hydroxyethyl(meth)acrylate, 2-hydroxypropyl(meth)acrylate, glycerol (meth)acrylate, polyethylene glycol (meth)acrylate, polypropylene glycol (meth)acrylate, ECH-modified butyl(meth)acrylate, ECH-modified phenoxy(meth)acrylate, EO-modified phthalic (meth)acrylate, EO-modified succinic (meth)acrylate, caprolactone-modified 2-hydroxyethyl(meth)acrylate, N,N-dimethylaminoethyl(meth)acrylate, N,N-diethylaminoethyl(meth)acrylate, EO-modified phosphoric (meth)acrylate, and the like.

Examples of the difunctional monomer include 1,3-butylene glycol di(meth)acrylate, 1,4-butylene glycol di(meth)acrylate, neopentyl glycol di(meth)acrylate, 1,6-hexane glycol di(meth)acrylate, ethylene glycol di(meth)acrylate, polyethylene glycol di(meth)acrylate, propylene glycol di(meth)acrylate, EO-modified neopentyl glycol di(meth)acrylate, PO-modified neopentyl glycol di(meth)acrylate, bisphenol A di(meth)acrylate, EO-modified bisphenol A di(meth)acrylate, ECH-modified bisphenol A di(meth)acrylate, EO-modified bisphenol S di(meth)acrylate, hydroxypivalic acid ester neopentyl glycol diacrylate, caprolactone-modified hydroxypivalic acid ester neopentyl glycol diacrylate, neopentyl glycol-modified trimethylolpropane di(meth)acrylate, stearyl acid-modified pentaerythritol di(meth)acrylate, dicyclopentenyl acrylate, EO-modified dicyclopentenyl(meth)acrylate, diacrylated isocyanurate, and the like.

Examples of the trifunctional monomer include trimethylolpropane tri(meth)acrylate, pentaerythritol tri(meth)acrylate, EO-modified trimethylolpropane tri(meth)acrylate, PO-modified trimethylolpropane tri(meth)acrylate, ECH-modified trimethylolpropane tri(meth)acrylate, ECH-modified glycerol tri(meth)acrylate, tris(acryloxyethyl)isocyanurate, tris(methacrylate ethyl)isocyanurate, and the like.

Examples of the polyfunctional monomer include ditrimethylolpropane tetra(meth)acrylate, pentaerythritol tetra(meth)acrylate, pentaerythritol tetra(meth)acrylate, dipentaerythritol monohydroxypenta(meth)acrylate, alkyl-modified dipentaerythritol pentaacrylate, dipentaerythritol hexa(meth)acrylate, caprolactone-modified dipentaerythritol hexa(meth)acrylate, and the like.

Examples of the oligomer include bisphenol A-type epoxy acrylates, novolac-type epoxy acrylates, polyhydric alcohol-type epoxy acrylates, polybasic acid-type epoxy acrylates, polybutadiene-type epoxy acrylates, polyester-type urethane acrylates, polyether-type urethane acrylates, and the like. Non-acrylic oligomers such as unsaturated polyesters may also be used. These oligomers may be used in combination.

Examples of the photoinitiator include hydrogen abstraction-type photoinitiators such as benzyl, benzophenone, Michler's ketone, 2-chlorothioxanthone, and 2,4-diethylthioxanthone, photocleavage-type photoinitiators such as benzoin ethyl ether, diethoxyacetophenone, benzyl methyl ketal, hydroxycyclohexyl phenyl ketone, and 2-hydroxy-2-methyl phenyl ketone, and the like. These photoinitiators may be used in combination.

It is preferable to use a photosensitizer together with photoinitiator. Examples of the photosensitizer include n-dibutylamine, triethylamine, triethylenetetramine, triethanolamine, and the like. These photosensitizers may be used in combination.

It is also preferable to add a silicone compound to the second coating material as an auxiliary agent. The water resistance, oil resistance, solvent resistance, and slip characteristics of the resulting writing paper 1 can be improved by adding the silicone compound.

This improves the erasability of the writing paper 1.

The silicone compound is preferably added in an amount of 1 to 3 wt % based on the amount of the second coating material.

Examples of the silicone compound include silicone additives (e.g., silicone oil and modified silicone oil). These silicone compounds may be used in combination.

The second coating material preferably includes 70 to 90 wt % of the acrylic monomer, 0 to 20 wt % of the acrylic oligomer, 1 to 10 wt % of the photoinitiator, and 2 to 5 wt % of a polymerization inhibitor and silicone oil (i.e., additives).

When forming three or more coating layers, a coating material including components similar to those of the second coating material may be used as a coating material applied over the second coating layer. A silicone compound may also be added to the first coating material. Only the outermost coating layer may be formed using the second coating material, and the remaining coating layers may be formed using the first coating material.

### (C) Application Amount of Coating Material and Thickness of Coating Layer

The first coating material is preferably applied in an amount equal to 1/10th to 9/10th (weight ratio) of the application amount of the second coating material.

The erasability of the writing paper 1 is improved by forming the second coating layer 4 formed of the second coating material to have a thickness larger than that of the first coating layer 3 formed of the first coating material within a given range.

Specifically, a situation in which a solvent and a pigment included in a whiteboard marker permeate the base 2 can be suppressed by forming the second coating layer to have a thickness larger than that of the first coating layer. Elevations and depressions formed by fibers that form the surface of the base 2 cannot be completely covered with the first coating layer. Elevations and depressions of the surface of the base can be covered by forming the second coating layer having a large thickness on the first coating layer, so that a situation in which a solvent included in a whiteboard marker permeates the base can be suppressed.

The first coating material is preferably applied in an amount of 1 to 3 g/m². In this case, the second coating material is preferably applied in an amount of 3 to 10 g/m², and more preferably 5 to 8 g/m². If the second coating material is applied in an amount of less than 3 g/m², an ink included in a whiteboard marker may easily permeate the paper base, so that the erasability of the writing paper 1 may deteriorate.

A thick coating film can be relatively easily formed if the coating material has low viscosity. It is preferable that the first coating material have a viscosity lower than that of the second coating material.

The thickness of the first coating layer 3 formed by applying the first coating material is preferably 1/10th to 9/10th, and more preferably ⅕th to ⅖th of the thickness of the second coating layer 4 formed by applying the second coating material.

The thickness of the first coating layer 3 is preferably 0.5 to 1.5 μm, and more preferably 0.7 nm to 1.3 μm.

A coating area of a UV-curable varnish may be formed on only part of the writing paper 1 so that only the coating area allows writing and erasure.

FIG. 2 shows a portable whiteboard 10 as an example of the writing paper 1 according to this embodiment.

### <Method of Producing Writing Paper>

A method of producing the writing paper according to this embodiment is described below with reference to FIG. 3. FIG. 3 is a view showing a process that produces the writing paper according to this embodiment using an offset press 20.

### (1) Application of First Coating Material

The first coating material is applied to paper (i.e., base 2) using a finish printing unit 21 of the offset press 20 that includes a coating unit shown in FIG. 3 to form the first coating layer 3.

### (2) Application of Second Coating Material

The second coating material is applied to the first coating layer 3 using a coating unit 22 of the offset press 20 shown in FIG. 3 to form the second coating layer 4.

### (3) Application of Ultraviolet Rays

The first coating layer 3 and the second coating layer 4 are cured by applying ultraviolet rays to the first coating layer 3 and the second coating layer 4 using a UV dryer 23 of the offset press 20 shown in FIG. 3 so that the first coating layer 3, the second coating layer 4, and the base 2 are strongly bonded.

In this case, the first coating layer and the second coating layer are cured before the first coating material applied to the paper or the first coating material and the second coating material are absorbed into the paper so that holes are formed in the second coating layer. When forming three or more coating layer, these layers are cured before the coating material is absorbed into the paper so that holes are formed in the coating layer.

The writing paper 1 in which the first coating layer 3, the second coating layer 4, and the like are rarely removed from the base 2, and cracks, scratches, and the like rarely occur, can be produced by utilizing a UV-curable varnish as the coating material, and curing the UV-curable varnish by applying ultraviolet rays. Moreover, the erasability of the writing paper 1 can be improved by quickly drying and curing the coating material by applying ultraviolet rays before holes are formed in the coating layer.

A UV offset press, a flexo-graphic press, a gravure printing press, or the like may be used to produce the writing paper 1.

As described above, the writing paper and the method of producing the same according to this embodiment can easily and inexpensively provide high-quality writing paper that exhibits an excellent writing capability and erasability, and rarely suffers delamination (removal), cracks, scratches, and the like.

According to this embodiment, since the two coating layers are formed (stacked) using two types of UV-curable varnish, the area thus formed is not removed from the paper base layer. It is possible to produce writing paper that is suitable for writing and erasure by adjusting the components and the application amount of the varnish and the thickness of the coating layer.

The coating material can be applied to the base 2, and the coating layers can be formed and UV-cured by a single production process (i.e., the base 2 is passed through the printing press once) by utilizing an offset press including a coating unit.

Therefore, the writing paper according to this embodiment can be inexpensively produced, and delivered quickly.

Since the writing paper according to this embodiment allows use of normal printing paper as the base 2, writing paper of various sizes can be produced from a single sheet coated with the coating material. It is also possible to deal with various types of bookbinding (e.g., leaf, saddle stitching, Ajiro binding, perfect binding, O-ring, and folding). Moreover, a UV varnish area (writing/erasure area) can be formed on part of the base.

The writing paper according to this embodiment can be used as a portable whiteboard that need not be transferred to and installed in a meeting/presentation hall or the like.

According to this embodiment, environmentally friendly writing paper can be provided. Specifically, a safe UV-curable varnish used for food packages, an ink compliant with the Voluntary Regulations Concerning Printing Inks (Negative List (NL) Regulations) established by the Japan Printing Ink Makers Association, or the like can be used as a UV-curable varnish or the like, and the writing paper can be disposed of as burnable waste after use. The paper base can be recycled as paper.

### Second Embodiment

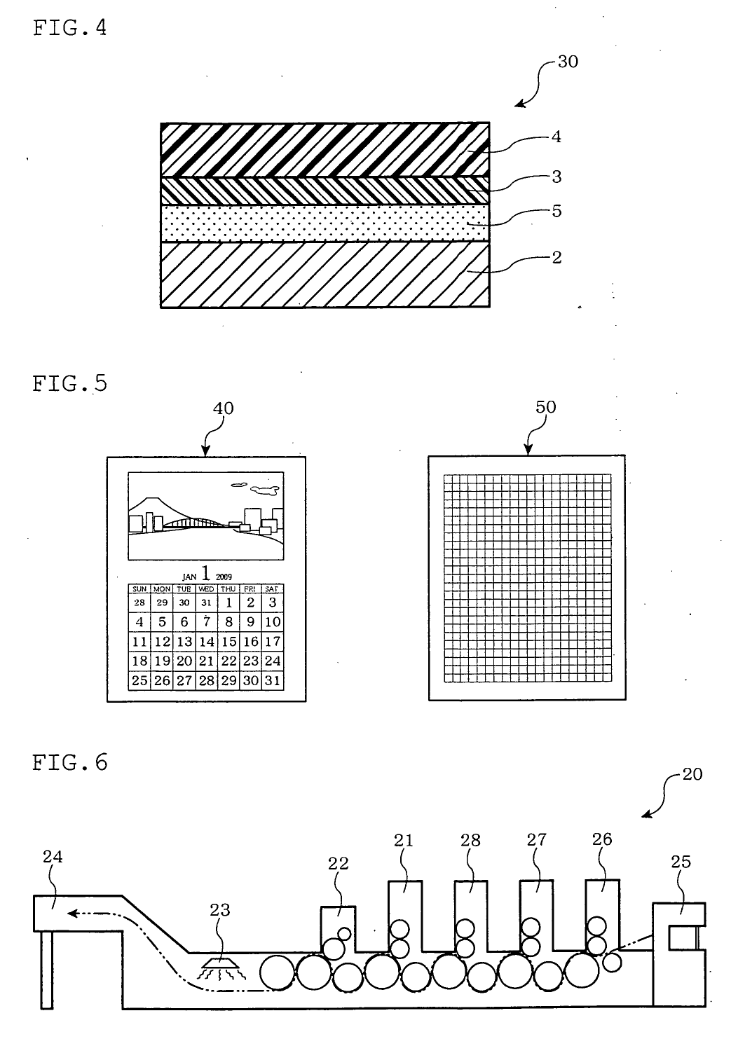

Writing paper according to a second embodiment of the invention is described below with reference to FIGS. 4 and 5. FIG. 4 is a cross-sectional view showing the configuration of the writing paper according to this embodiment, and FIG. 5 is a view showing a calendar and graph paper produced using the writing paper according to this embodiment.

As shown in FIG. 4, writing paper 30 according to this embodiment includes a base 2, a printing ink layer 5, a first coating layer 3 that is formed of a first coating material, and a second coating layer 4 that is formed of a second coating material.

Specifically, the writing paper 30 according to this embodiment includes the printing ink layer 5 with printed characters, figures, colors, and the like on the base 2. The first coating layer 3 and the second coating layer 4 are formed on the printing ink layer 5. The writing paper 30 according to this embodiment has the same configuration as that of the first embodiment except for the above feature. The material for each layer, the application amount of each material, the thickness of each layer, and the like may be the same as those described in connection with the first embodiment.

### (Printing Ink Layer)

The printing ink layer 5 is formed by printing characters, figures, colors, and the like on the base 2. The first coating layer 3 is formed on the printing ink layer 5.

The printing ink layer 5 is preferably applied in an amount of 0.4 to 2.0 g/m², and more preferably 0.8 to 1.4 g/m² in order to ensure that the writing paper exhibits an excellent writing capability and erasability.

The optimum thickness of the printing ink layer 5 differs depending on the printing method (e.g., process color printing (four-color (black, cyan, magenta, and yellow) printing), monochrome printing, and spot color printing). The thickness of the printing ink layer 5 is preferably 0.5 to 1.5 μm, and more preferably 0.7 to 1.3 μm in order to ensure that the writing paper exhibits an excellent writing capability and erasability.

If the thickness of the printing ink layer 5 is less than 0.5 μm, the printing ink may not be advantageously transferred to the base 2. If the thickness of the printing ink layer 5 is more than 1.5 μm, insufficient UV-curing (offset) may occur during the production process.

The printing ink layer 5 may be formed by process color printing, monochrome printing, or spot color printing using a printing press such as a UV offset press.

FIG. 5 shows a calendar 40 and graph paper 50 as examples of the writing paper 30 according to this embodiment.

### <Method of Producing Writing Paper>

A method of producing the writing paper according to this embodiment is described below with reference to FIG. 6. FIG. 6 is a view showing a process that produces the writing paper according to this embodiment using an offset press 20.

### (1) Printing of Characters, Figures, Colors, and the Like

The printing ink layer 5 is formed by printing characters, figures, colors, and the like on the base 2 using a printing unit 26, a printing unit 27, or a printing unit 28 of an offset press 20 shown in FIG. 6 that includes a coating unit.

When forming a process color (four-color) ink layer, the printing ink layer 5 is formed using the printing unit 26, the printing unit 27, the printing unit 28, and a finish printing unit 21. In this case, the following steps are performed by passing the base 2 on which the printing ink layer 5 has been formed through the offset press 20 again.

### (2) Application of First Coating Material

The first coating material is applied to the printing ink layer 5 using the finish printing unit 21 of the offset press 20 shown in FIG. 6 to form the first coating layer 3.

### (3) Application of Second Coating Material

The second coating material is applied to the first coating layer 3 using a coating unit 22 of the offset press 20 shown in FIG. 6 to form the second coating layer 4.

### (4) Application of Ultraviolet Rays

The first coating layer 3 and the second coating layer 4 are cured by applying ultraviolet rays to the first coating layer 3 and the second coating layer 4 using a UV dryer 23 of the offset press 20 shown in FIG. 6 so that the first coating layer 3, the second coating layer 4, the base 2, and the printing ink layer 5 are strongly bonded.

The writing paper 30 in which the first coating layer 3 and the second coating layer 4 are rarely removed from the base 2 and the printing ink layer 5, and cracks, scratches, and the like rarely occur, can be produced by utilizing a UV-curable varnish as the coating material, and curing the UV-curable varnish by applying ultraviolet rays.

As described above, this embodiment can provide writing paper on which characters, figures, and the like are printed while achieving the effects of the writing paper according to the first embodiment.

Therefore, the writing paper according to this embodiment may suitably be applied to a calendar, graph paper, plotting paper, a schedule, and the like.

### Third Embodiment

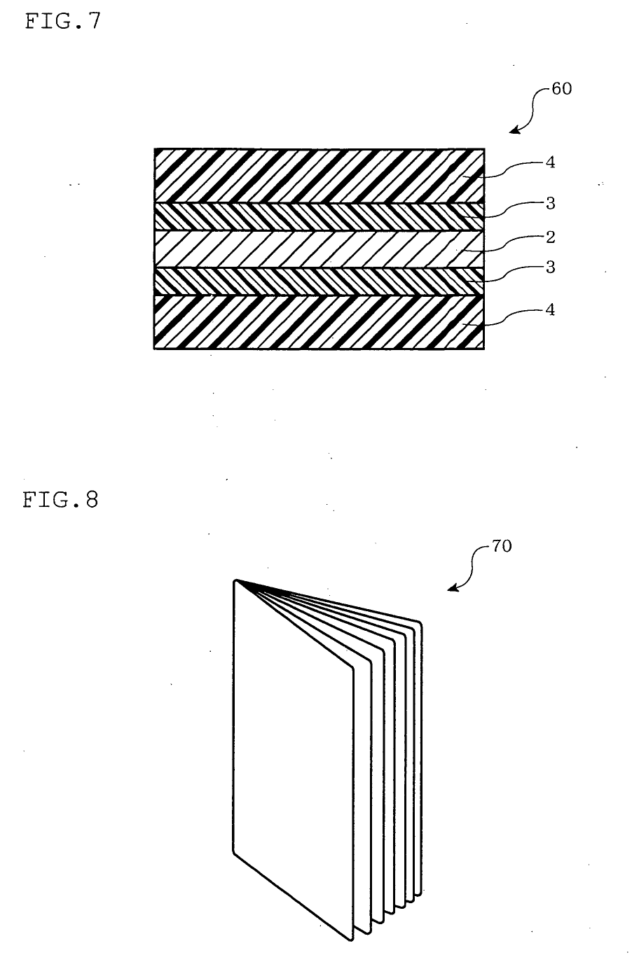

Writing paper according to a third embodiment of the invention is described below with reference to FIGS. 7 and 8. FIG. 7 is a cross-sectional view showing the configuration of the writing paper according to this embodiment, and FIG. 8 is a view showing a notebook produced using the writing paper according to this embodiment.

As shown in FIG. 7, writing paper 60 according to this embodiment includes a base 2, first coating layers 3 that are formed on either side of the base 2 and are formed of a first coating material, and second coating layers 4 that are respectively formed on both of the first coating layers 3 and are formed of a second coating material.

Specifically, the writing paper 60 according to this embodiment is produced by applying the first coating material to the uncoated side of the base 2 of the writing paper 1 according to the first embodiment using an offset press or the like to form another first coating layer 3, and applying the second coating material to the other first coating layer 3 to form another second coating layer 4. Therefore, the writing paper 60 according to this embodiment is produced by passing the base 2 through a printing press twice. The writing paper 60 according to this embodiment has the same configuration as that of the first embodiment except for the above feature. The material for each layer, the application amount of each material, the thickness of each layer, and the like may be the same as those described in connection with the first embodiment.

For example, a notebook 70 shown in FIG. 8 and the like can be provided by forming the first coating layer 3 and the second coating layer 4 on each side of the base 2.

### Fourth Embodiment

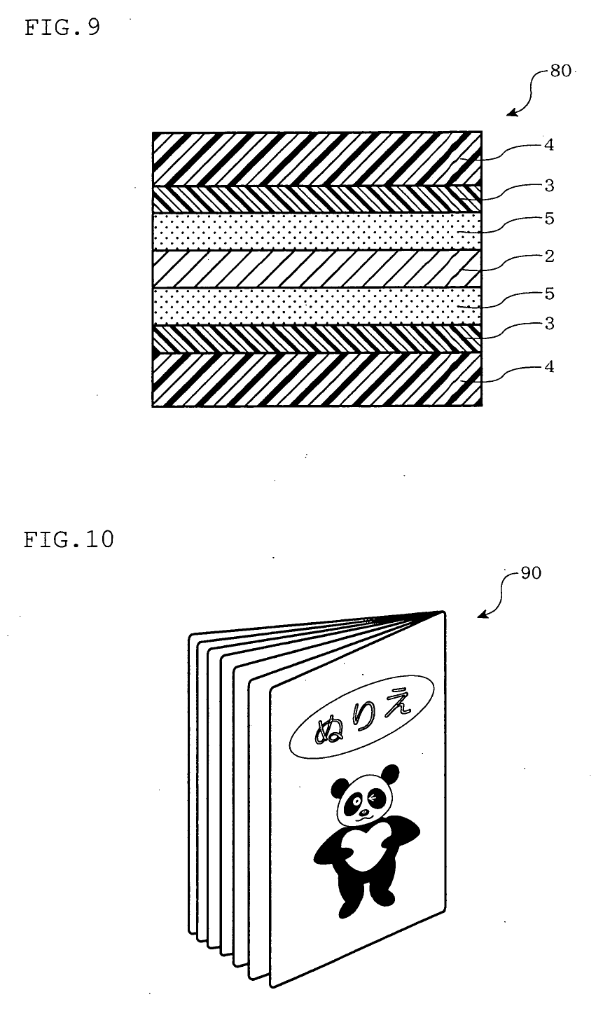

Writing paper according to a fourth embodiment of the invention is described below with reference to FIGS. 9 and 10. FIG. 9 is a cross-sectional view showing the configuration of the writing paper according to this embodiment, and FIG. 10 is a view showing a coloring book produced using the writing paper according to this embodiment.

As shown in FIG. 9, writing paper 80 according to this embodiment is composed of seven layers, i.e., a base 2, printing ink layers 5 formed on either side of base 2, first coating layers 3 that are respectively formed on both of the printing ink layers 5 and are formed of a first coating material, and second coating layers 4 that are respectively formed on both of the first coating layers 3 and are formed of a second coating material.

Specifically, the writing paper 80 according to this embodiment is produced using an offset press or the like by forming another printing ink layer 5 on the uncoated side of the base 2 of the writing paper 30 according to the second embodiment, applying the first coating material to the other printing ink layer 5 to form another first coating layer 3, and applying the second coating material to the other first coating layer 3 to form another second coating layer 4. Therefore, the writing paper 80 according to this embodiment is produced by passing the base 2 through a printing press twice. The writing paper 80 according to this embodiment has the same configuration as that of the second embodiment except for the above feature. The material for each layer, the application amount of each material, the thickness of each layer, and the like may be the same as those described in connection with the first embodiment.

For example, a coloring book 90 shown in FIG. 10 and the like can be provided by forming the printing ink layer 5, the first coating layer 3, and the second coating layer 4 on each side of the base 2.

### EXAMPLES

### Example 1

Normal printing paper (coated paper manufactured by Oji Paper Co., Ltd.) was used as the base 2, and a UV-curable overprint (OP) varnish (UVL Carton OP Varnish manufactured by T&K TOKA Corporation, Anchor A) was used as the first coating material. Varnish (hereinafter referred to as “coat varnish A”) containing 70 to 90 wt % of an acrylic monomer, 0 to 20 wt % of an acrylic oligomer, 1 to 10 wt % of a photoinitiator, a polymerization inhibitor, and 2 to 5 wt % of a slipping agent was used as the second coating material.

The first coating material and the second coating material were sequentially applied to the base 2 using a UV offset press including a coating unit (“New DAIYA 304” manufactured by Mitsubishi Heavy Industries, Ltd.) to produce the writing paper 1.

### Example 2

The base 2 and the first coating material used in Example 1 were used. Varnish (hereinafter referred to as “coat varnish B”) containing 70 to 90 wt % of an acrylic monomer, 0 to 20 wt % of an acrylic oligomer, 1 to 10 wt % of a photoinitiator, a polymerization inhibitor, and 2 to 5 wt % of a silicone additive (silicone oil) was used as the second coating material. The writing paper 1 was produced in the same manner as in Example 1.

### Example 3

The base 2 and the first coating material used in Example 1 were used. Varnish (hereinafter referred to as “coat varnish C”) containing 70 to 90 wt % of an acrylic monomer, 0 to 20 wt % of an acrylic oligomer, 10 to 20 wt % of a photoinitiator, and a polymerization inhibitor was used as the second coating material. The writing paper 1 was produced in the same manner as in Example 1.

### Example 4

The base 2 and the first coating material used in Example 1 were used. A low-viscosity varnish (hereinafter referred to as “coat varnish D”) containing 70 to 90 wt % of an acrylic monomer, 0 to 20 wt % of an acrylic oligomer, 1 to 10 wt % of a photoinitiator, and a polymerization inhibitor was used as the second coating material. The writing paper 1 was produced in the same manner as in Example 1.

### Comparative Example 1

The base 2 and the first coating material used in Example 1 were used. Writing paper including one coating layer was produced using the UV offset press used in Example 1 without using the second coating material.

### Example 5

The base 2 used in Example 1 was used. A UV-curable medium (UVL Carton Medium manufactured by T&K TOKA Corporation, Anchor B) was used as the first coating material. The coat varnish A used in Example 1 was used as the second coating material. The writing paper 1 was produced in the same manner as in Example 1.

### Example 6

The base 2 and the first coating material used in Example 5 were used. The coat varnish B used in Example 2 was used as the second coating material. The writing paper 1 was produced in the same manner as in Example 1.

### Example 7

The base 2 and the first coating material used in Example 5 were used. The coat varnish C used in Example 3 was used as the second coating material. The writing paper 1 was produced in the same manner as in Example 1.

### Example 8

The base 2 and the first coating material used in Example 5 were used. The coat varnish D used in Example 4 was used as the second coating material. The writing paper 1 was produced in the same manner as in Example 1.

### Comparative Example 2

The base 2 and the first coating material used in Example 5 were used. Writing paper including one coating layer was produced using the UV offset press used in Example 1 without using the second coating material.

### Comparative Example 3

The base 2 used in Example 1 was used. The first coating material was not used. The coat varnish A used in Example 1 was used as the second coating material. Writing paper including one coating layer was produced using the UV offset press used in Example 1.

### Comparative Example 4

The base 2 used in Example 1 was used. The first coating material was not used. The coat varnish B used in Example 2 was used as the second coating material. Writing paper including one coating layer was produced using the UV offset press used in Example 1.

### Comparative Example 5

The base 2 used in Example 1 was used. The first coating material was not used. The coat varnish C used in Example 3 was used as the second coating material. Writing paper including one coating layer was produced using the UV offset press used in Example 1.

### Comparative Example 6

The base 2 used in Example 1 was used. The first coating material was not used. The coat varnish D used in Example 4 was used as the second coating material. Writing paper including one coating layer was produced using the UV offset press used in Example 1.

### (Writing Test)

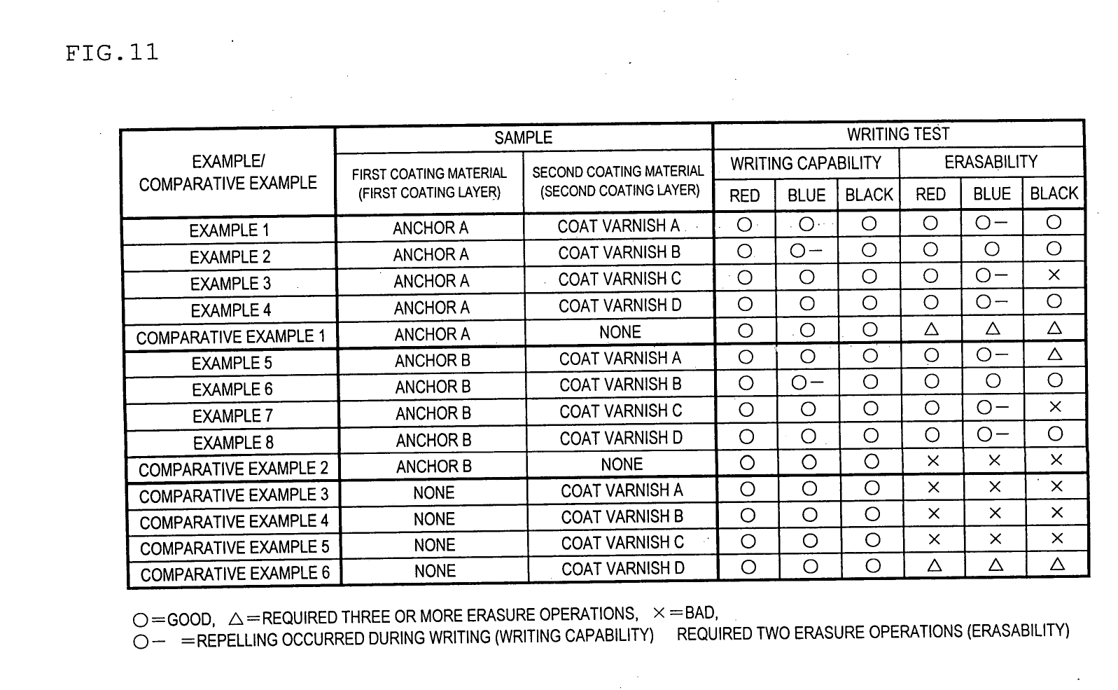

The writing capability and the erasability of the writing papers produced in Examples 1 to 8 and Comparative Examples 1 to 6 were evaluated. Whiteboard markers (red: Mitsubishi Pencil Whiteboard Marker (manufactured by Mitsubishi Pencil Co., Ltd), blue: Mitsubishi Pencil Whiteboard Marker (manufactured by Mitsubishi Pencil Co., Ltd), and black: Kokuyo whiteboard Marker (manufactured by Kokuyo Co., Ltd.) were used as writing materials. A whiteboard erasure (manufactured by Ohto Co., Ltd.) was used as an erasing tool. The results are shown in FIG. 11.

As shown in FIG. 11, the writing papers produced in Comparative Examples 1 and 2 (i.e., the second coating material was not used (i.e., the second coating layer was not formed)) exhibited an excellent writing capability, but had poor erasability.

The writing papers produced in Comparative Examples 3 to 6 (i.e., the first coating material was not used (i.e., the first coating layer was not formed)) exhibited an excellent writing capability, but had poor erasability.

In Examples 1 to 8, an excellent writing capability and excellent erasability were obtained except for the case where the coat varnish A was used as the second coating material (Example 5), and the case where the coat varnish C was used (Examples 3 and 7) (i.e., it took time to erase the black whiteboard marker to some extent).

When using the coat varnish B, the blue whiteboard marker was repelled during writing, but excellent erasability was obtained for each whiteboard marker.

When using the coat varnish D, an excellent writing capability was obtained for each whiteboard marker, and only the blue whiteboard marker required two erasure operations.

As is clear from the above results, it was confirmed that writing paper that exhibits an excellent writing capability and erasability can be produced by forming the first coating layer and the second coating layer using the UV-curable coating materials.

The invention is not limited to the above embodiments and examples. Various modifications may be made without departing from the scope of the invention.

For example, although the above embodiments and examples illustrate the case where two coating layers are formed on a single side of paper using a UV-curable paint, three or more coating layers may be appropriately formed on a single side of paper. In this case, writing paper can be provided with excellent erasability by forming one or more layers formed on the first coating layer formed on paper to have a thickness larger than that of the first coating layer. An arbitrary coating layer positioned between the first coating layer and the outermost coating layer may be formed by applying the first coating material or the second coating material.

When forming three or more coating layers, a printing ink layer may be formed between the coating layers. In this case, it is preferable to form the coating layer positioned on each side of the printing ink layer using the first coating material used in Example 5. This is because the coating material used in Example 5 exhibits good adhesion to the printing ink layer.

### INDUSTRIAL APPLICABILITY

The invention may suitably be used to produce a portable whiteboard, a calendar, graph paper, a notebook, a coloring book for children and infants, and the like.

1. Writing paper comprising a first coating layer formed by applying a first coating material to one side or each side of paper, and a second coating layer formed by applying a second coating material to the first coating layer, the first coating material and the second coating material being UV-curable, and the second coating layer having a thickness larger than that of the first coating layer.

2. The writing paper according to claim 1, wherein the second coating material has a viscosity lower than that of the first coating material.

3. The writing paper according to claim 1, wherein the first coating layer has been formed by applying the first coating material to the paper in an amount of 1 to 3 g/m², and the second coating layer has been formed by applying the second coating material to the first coating layer in an amount of 3 to 8 g/m².

4. The writing paper according to claim 1, wherein the first coating material and the second coating material include at least 70 to 90 wt % of an acrylic monomer, 0 to 20 wt % of an oligomer, and 1 to 10 wt % of a photoinitiator.

5. The writing paper according to claim 1, wherein the second coating material includes a silicone compound.

6. The writing paper according to claim 1, further comprising a printing ink layer that includes a printing ink and is positioned between the first coating layer and the paper.

7. The writing paper according to claim 1, the writing paper being used as paper that forms a notebook, a portable whiteboard, simili paper, a coloring book, or a calendar.

8. A method of producing writing paper comprising coating the entirety or part of one side or each side of paper with two or more UV-curable coating materials to form two or more coating layers on one side or each side of the paper.

9. The method according to claim 8, further comprising curing the two or more coating layers before the coating material is absorbed into the paper so that holes are formed in the two or more coating layers.

10. The method according to claim 8, wherein at least the coating material that forms the outermost coating layer includes at least 70 to 90 wt % of an acrylic monomer, 0 to 20 wt % of an oligomer, 1 to 10 wt % of a photoinitiator, and 2 to 5 wt % of a silicone compound.

11. The method according to claim 8, further comprising printing characters, figures, colors, and the like on the paper by process color printing, monochrome printing, or spot color printing using a printing press, and applying the coating material to a layer that includes the printed characters, figures, colors, and the like.
